(19) United States
(12) Patent Application Publication
(10) Pub. No.: US 2016/0306940 A1
(43) Pub. Date: Oct. 20, 2016

(54) SYSTEM, METHOD, AND COMPUTER PROGRAM FOR RESPIRATORY AND CARDIOVASCULAR MONITORING, EVALUATION, AND TREATMENT

(71) Applicant: MOHAMED HUSSAM FARHOUD REVOCABLE TRUST, WICHITA, KS (US)

(72) Inventor: MOHAMED HUSSAM FARHOUD, WICHITA, KS (US)

(73) Assignee: MOHAMED HUSSAM FARHOUD REVOCABLE TRUST, WICHITA, KS (US)

(21) Appl. No.: 15/097,381

(22) Filed: Apr. 13, 2016

Related U.S. Application Data
(60) Provisional application No. 62/147,902, filed on Apr. 15, 2015.

(51) Int. Cl. G06F 19/00; G06F 1/16; H04W 4/00; A41D 1/04; A41D 1/00

(52) U.S. Cl. CPC G06F 19/3418; G06F 19/323; A41D 1/04; A41D 1/002; H04W 4/008; G06F 1/163; A41D 2400/44; A41D 2400/70

(57) ABSTRACT

A patient respiratory and cardiovascular monitoring and evaluation system broadly comprising a wearable respiratory and cardiovascular monitoring garment, a number of sensors and microphones, and a patient computing device. The sensors may be positioned on various locations of the wearable garment for sensing heat rate, blood pressure, and thoracic impedance, among other vital health information. The microphones may similarly be positioned on various locations of the wearable garment for sensing lung and heart auscultations. The wearable garment may be worn close to the patient's chest wall for improving sensor and microphone data while retaining patient mobility. The patient computing device runs a monitoring application thereon and includes a graphical user interface having a number of virtual inputs for allowing the patient to initiate self-monitoring sessions and manage the signals and computer data received from the sensors and microphones.

### RELATED APPLICATIONS

This patent application is a nonprovisional regular utility application, and claims priority benefit with regard to all common subject matter, of earlier-filed U.S. Provisional Patent Application Ser. No. 62/147,902, filed on Apr. 15, 2015, and entitled “SYSTEM, METHOD, AND COMPUTER PROGRAM FOR RESPIRATORY AND CARDIOVASCULAR MONITORING, EVALUATION, AND TREATMENT.” The identified earlier filed provisional patent application is hereby incorporated by reference in its entirety into the present application.

### BACKGROUND

Health monitoring devices are often used for collecting patient health information and for diagnosing patient health issues. For example, physicians often use blood pressure testers to determine blood pressure and heart monitors to determine heart rates of their patients. However, these devices restrict patient movement and/or require patients to be physically connected to stationary machines. Some health monitoring devices cannot be self-operated because they restrict the patients' movements yet require two hands or complete mobility to operate. Health monitoring devices also often require medical training or specific computer knowledge before use. Furthermore, many health monitoring devices allow only a single patient to be monitored at a time.

### SUMMARY

Embodiments of the present invention solve the above-mentioned problems and provide a distinct advance in the art of patient health monitoring systems. More particularly, the present invention provides a non-invasive patient health monitoring system that allows a patient to easily initiate self-health monitoring sessions with minimal or no medical training or computer knowledge. The monitoring system also allows a caregiver to easily monitor a number of patients simultaneously.

An embodiment of the present invention is a non-invasive respiratory and cardiovascular monitoring system broadly comprising a vest or other wearable garment, a number of sensors positioned on or embedded in the garment, a number of microphones positioned on or embedded in the garment, a processor, a memory, and a transceiver. The garment may be any article of clothing or other covering configured to be worn close to a patient's chest wall and may include a neck opening, left and right arm openings, and a torso opening. The sensors may be positioned on various locations of the garment for sensing heart rate, blood pressure, and thoracic impedance, among other vital health information of a patient. The microphones may similarly be positioned on various locations of the garment for sensing lung and heart auscultations. The processor may be located in or on the garment or in a separate electronic device and controls the sensors and microphones. The memory may be located in or on the garment or in a separate electronic device and stores signals received from the sensors and microphones until the signals can be transmitted to a patient computing device or caregiver computing device. The transceiver may be located in or on the garment and transmits the signals to the patient or caregiver computing device. The garment may be worn close to the patient's chest wall for improving sensor and microphone effectiveness while retaining patient mobility. In this way, the patient's health may be monitored without affecting the patient's movements or daily routine.

Another embodiment of the present invention is a non-invasive respiratory and cardiovascular monitoring system broadly comprising a vest or other wearable garment, a number of sensors positioned on or embedded in the garment, a number of microphones positioned on or embedded in the garment, a processor, a memory, a transceiver, and a patient computing device in wireless communication with the processor. The garment may include a neck opening, left and right arm openings, and a torso opening. The sensors may be positioned on various locations of the garment for sensing heart rate, blood pressure, and thoracic impedance, among other vital health information of a patient. The microphones may similarly be positioned on various locations of the garment for sensing lung and heart auscultations. The processor may be located in or on the garment or in a separate electronic device and controls the sensors and microphones. The memory may be located in or on the garment or in a separate electronic device and stores signals received from the sensors and microphones until the signals can be transmitted to the patient computing device or a caregiver computing device. The transceiver may be located in or on the garment or in a separate electronic device and transmits the signals to the patient computing device or the caregiver computing device. The garment may be worn close to the patient's chest wall for improving sensor and microphone data while retaining patient mobility. The patient computing device runs a monitoring application thereon and includes a graphical user interface having a number of virtual inputs for allowing the patient to initiate self-monitoring sessions and manage the signals and computer data received from the garment.

### BRIEF DESCRIPTION OF THE DRAWING FIGURES

Embodiments of the present invention are described in detail below with reference to the attached drawing figures, wherein:

FIG. 1 is a schematic view of a respiratory and cardiovascular monitoring and evaluation system constructed in accordance with an embodiment of the present invention;

FIG. 2 is a front elevation view of a vest of the respiratory and cardiovascular monitoring and evaluation system of FIG. 1;

FIG. 3 is a rear elevation view of the vest of the respiratory and cardiovascular monitoring and evaluation system of FIG. 1;

FIG. 4 is a schematic view of sensing and electronic components of the vest of the respiratory and cardiovascular monitoring and evaluation system of FIG. 1; and

FIG. 5 is a flow diagram of a method of monitoring and evaluating a patient via the respiratory and cardiovascular monitoring and evaluation system of FIG. 1.

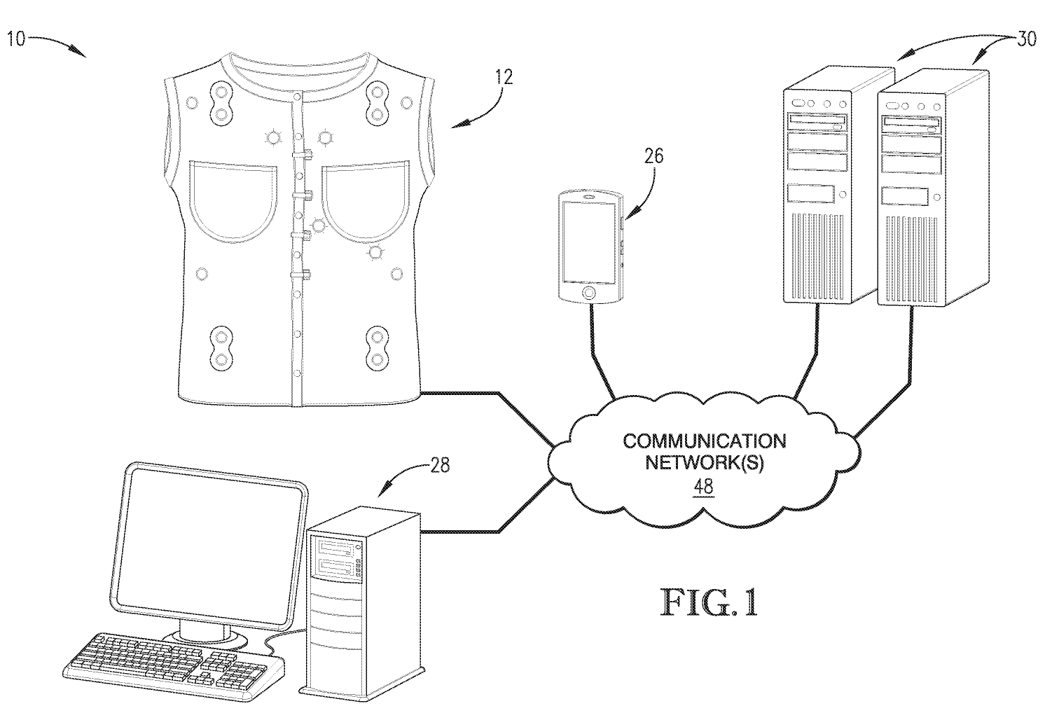

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

With reference to the drawing figures, the present invention provides various embodiments of a system 10, method, and computer program for comprehensively monitoring, evaluating, diagnosing, and treating respiratory and cardiovascular health issues of a patient. The system 10 broadly comprises a wearable garment 12, a plurality of sensors 14, a plurality of microphones 16, a processor 18, a memory 20, a transceiver 22, a power source 24, one or more patient computing devices 26, one or more caregiver computing devices 28, and a healthcare provider computing system 30.

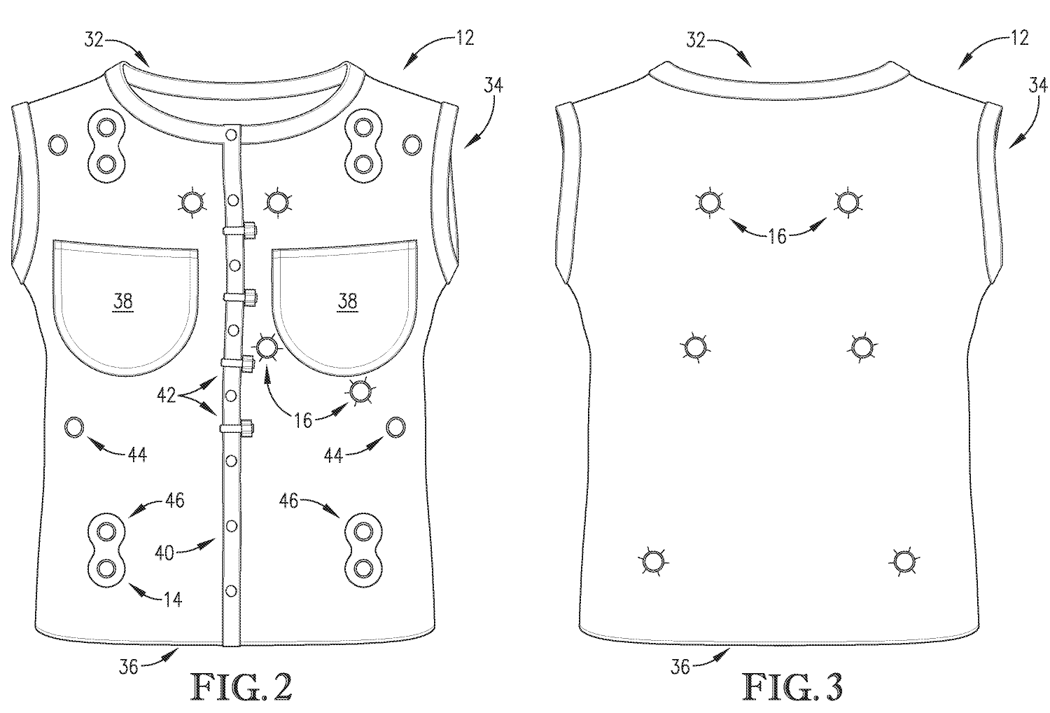

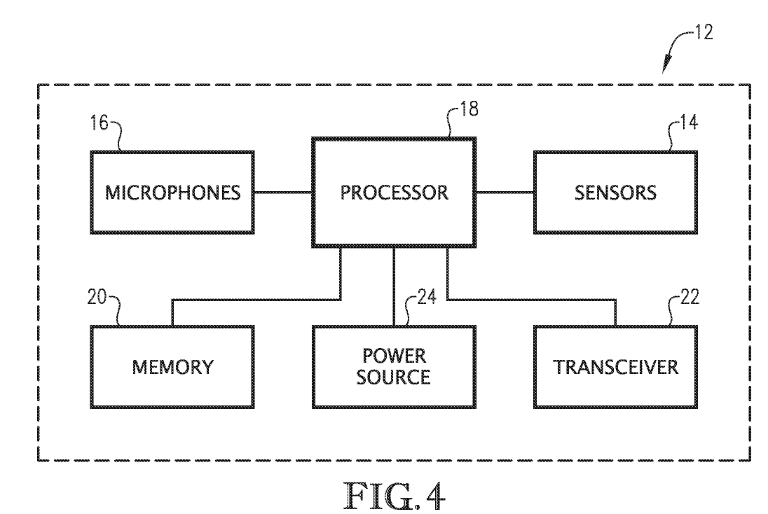

The wearable garment 12 contacts or is worn closely to the patient's torso or chest wall and broadly includes a neck opening 32, left and right arm openings 34, a torso opening 36, left and right fenestrated areas 38, and a front placket 40, and one or more adjustable buckles 42, as best shown in FIGS. 2 and 3. The wearable garment 12 may be formed of nylon, cotton, polyester, or any other natural or synthetic textile material and may be washable, reusable, and/or disposable. The wearable garment 12 may be a vest, shirt, undergarment, jacket, sweater, parka, robe, wrap, or any other suitable wearable garment.

The neck opening 32, arm openings 34, and torso opening 36 receive the wearer's neck, arms, and torso therethrough and may be of conventional size and positioning. The openings may each include opening edges (i.e., “facing”), fabric reinforcements, collars, cuffs, drawstrings, or other textile bordering.

The left and right fenestrated areas 38 receive the patient's breasts or other soft tissue therethrough for ensuring a closer fit to the chest wall. The left and right fenestrated areas 38 may be openings or pouch-like areas and may have a curved lower edge and a straight or flat upper edge for more easily donning the wearable garment 12. The left and right fenestrated areas 38 may include textile bordering as described above.

The front placket 40 enables the patient to put on and take off the wearable garment 12 easier and may include left and right bordering (as described above) and buttons, snaps, a zipper, hook and loop fasteners (e.g., Velcro®), or any other type of fastener for removably and adjustably connecting the left front portion of the wearable garment 12 to the right front portion of the wearable garment 12. The front placket 40 may extend from the front of the neck opening 32 to the front of the torso opening 36 or partway from the neck opening 32 or torso opening 36 to the opposite opening.

The buckles 42 adjustably secure the wearable garment 12 on the patient's torso and may include removably inter-connecting snaps, straps, belts, clasps, or any other clothing fastener. The buckles may be vertically spaced along the front placket 40 for securing the left and right front portions of the wearable garment 12 together.

The sensors 14 detect respiratory, cardiovascular, and other vital information of the patient's health and may comprise a number of electrocardiography (EKG) sensors 44, non-invasive hemodynamic sensors 46, temperature sensors, and any other type of health monitoring sensor. The EKG sensors 44 detect heart rate and rhythm abnormalities and in one embodiment include four EKG patches. The EKG patches may be positioned in the upper right front area, upper left front area, middle right front area, and middle left front area, or any other suitable area of the wearable garment 12. The non-invasive hemodynamic sensors 46 detect blood pressure, heart rate, and thoracic impedance and in one embodiment include four hemodynamic sensors positioned in the upper right front area, upper left front area, lower right front area, and lower left front area of the wearable garment 12. It will be understood that different types and any number of sensors may be embedded in or positioned at different locations on the wearable garment 12 for obtaining similar readings.

The microphones 16 detect lung and heart auscultations and other vibrations. The microphones 16 may be positioned in the upper left back area, upper right back area, middle left back area, middle right back area, lower left back area, lower right back area, upper right front area near the midline, upper left front area near the midline, middle left side near the midline, and middle of the left side. The back six positions correspond to the lung apex, mid-lung fields, and lung bases, respectively. The front four positions correspond to the second right intercostal space/aortic valve area, the second left intercostal space/pulmonic valve area, the fourth left intercostal space/tricuspid valve area, and fifth intercostal space/mitral valve area. In one embodiment, the microphones 16 include ten microphones spaced along the wearable garment 12. It will be understood that different types and any number of microphones may be embedded in or positioned at different locations on the wearable garment 12 for obtaining similar readings.

The processor 18 receives signals from the sensors 14 and microphones 16 and transmits them to the patient computing device 26 and/or the healthcare provider computing system 30 via the transceiver 22. The processor 18 may be a small computer chip embedded in or positioned on or near the wearable garment 12 and may include a memory for temporarily storing signal data, recordings, and other information. The processor 18 may encrypt the data before transmitting it so that the system 10 complies with HIPPA and other privacy regulations.

The memory 20 retains signal data, recordings, and other information thereon and may be an SD card, flash memory, or other similar memory element. The memory 20 may be removable from the wearable garment 12 or may be connectable to computing devices via a USB port or other similar port.

The transceiver 22 transmits signal data, recordings, and other information from the processor 18 to the patient computing device 26 and/or the healthcare provider computing system 30. The transceiver 22 may transmit the data via Bluetooth, NFC technology, radio frequency transmissions, wifi, SMS, a wireless communication network 48 (described below), or any other communication technology. The transceiver 22 may be embedded in or positioned on or near the wearable garment 12.

The wireless communication network 48 is preferably the Internet but may be any other wireless communication network such as a local area network, a wide area network, or an intranet. The wireless communications network 48 may include or be in communication with a network capable of supporting wireless communications such as the wireless networks operated by AT&T, Verizon, or Sprint. The wireless communication network 48 may also be combined or implemented with several different networks.

The power source 24 powers the sensors 14, microphones 16, processor 18 and transceiver 22 and may be a rechargeable or disposable battery, battery pack, or solar cell array. The power source 24 may be embedded in or positioned on or near the wearable garment 12.

The patient computing device 26 processes signals received from the sensors and microphones and compiles and analyzes data corresponding to the signals. The patient computing device 26 broadly includes a processor, memory, transceiver, display, and other computing elements. The patient computing device 26 may be a smartwatch, electronic wristband, smart phone, tablet, laptop, PDA, game system, desktop or personal computer, remote server, or any other portable or stationary computing device. The patient computing device 26 is configured to run programs and/or applications such as the monitoring application described below. The patient computing device 26 may also connect to the internet via the wireless communication network 48 for transmitting data to the caregiver computing device 28 and the healthcare provider computing system 30 and for loading websites on the device 26.

Embodiments of the patient computing device 26 and other computing devices and systems described herein may run Windows; LAMP (Linux, Apache HTTP server, MySQL, and PHP/Perl/Python); Java; AJAX; NT; Novel Netware; Unix; Mac OS; or any other software system. The computing devices may include or have access to computer memory and other hardware and software for receiving, storing, accessing, and transmitting information via the wireless communication network 48. The computing devices may also include conventional web hosting operating software, searching algorithms, and an Internet connection, and may be assigned URLs and corresponding domain names so that they can be accessed via the Internet in a conventional manner.

The patient computing device 26 and other computing devices and systems described herein each may run a computer program or programs, such as the monitoring application described below, for implementing certain steps of the present invention described herein. Portions of the computer program stored on memories of the computer systems can be updated via a computer readable medium, the wireless communication network 48, or a manual connection. Therefore, the computer program as described herein is to be understood as all code segments, either individually or collectively, that are executed to implement the steps and features of the present invention.

The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via optical scanning of the paper or other medium, then compiled, interpreted, or otherwise processed in a suitable manner, if necessary, and then stored in a computer memory. The various actions and calculations described herein as being performed by or using the computer program may actually be performed independently or cooperatively by one or more computers, processors, or other computational devices.

The monitoring application allows the patient to control the sensors 14, microphone 16, and processor 18 and may be a standalone program, applet, widget, website, or other similar computer program. The monitoring application may include a graphical user interface (GUI) having images, videos, and textual aids for providing step-by-step operating instructions to the patient and for assisting the patient in navigating the application. The GUI may also have virtual inputs for receiving commands and information from the patient, caregiver, or other user. For example, the monitoring application may include virtual buttons and file systems for calibrating the sensors and microphones, starting a monitoring session, managing sensor readings and other information, and selectively transmitting sensor readings and other information to other devices. The monitoring application may include a pre-developed archive of normal and abnormal pulmonary and cardiovascular patterns and changes stored on the memory of the patient computing device 26 or other computing system.

The caregiver computing device 28 analyzes and compiles information received from the patient computing device 26 and broadly includes a processor, memory, transceiver, display, and other computing elements. The caregiver computing device 28 may be a smartwatch, electronic wristband, smart phone, tablet, laptop, PDA, game system, desktop or personal computer, remote server, or any other portable or stationary computing device. The caregiver computing device 28 is configured to run programs and/or applications such as the monitoring application described above. The caregiver computing device 28 may also connect to the internet via a wireless communication network 48 for receiving data from the patient computing device 26, transmitting data to the healthcare provider computing system 30, and for loading websites on the patient computing device 26 and caregiver computing device 28.

The healthcare provider computing system 30 analyzes the data, recordings, and other information sent from the patient computing device 26 and may comprise one or more computing devices each including a processor, memory, transceiver, display, and other computing elements. The computing devices each may be a desktop or personal computer, remote server, or any other portable or stationary computing device.

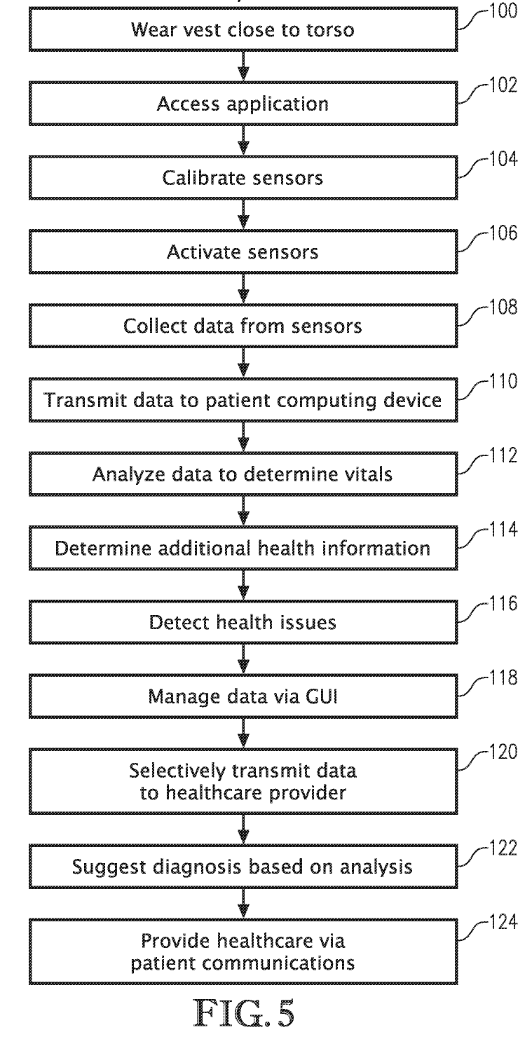

Use of the monitoring system 10 will now be described in more detail. A patient may wear the wearable garment 12 in contact with or in close proximity to the patient's torso, as shown in block 100 of FIG. 5. The patient may choose a vest that fits snugly around his or her torso or may choose a slightly larger or “one-size-fits-all” vest and tighten the buckles 42 until the wearable garment 12 fits closely to the patient's chest wall. The patient may position the wearable garment 12 such that his or her breasts or soft tissue are positioned in the left and right fenestrated areas 38 so that the wearable garment 12 sits closer to less fatty areas of the patient's torso. The sensors 14 and microphones 16 will naturally be positioned close to the monitored areas of the body when the patient is wearing the wearable garment 12 in a conventional manner. The patient may then fasten the buttons of the front placket 40 and the buckles 42 so as to secure the wearable garment 12 around his torso.

The patient may then download the application onto the patient computing device 26 (e.g., the patient's personal smartphone or a hospital-issued mobile device) if he does not already have the application loaded thereon, as shown in block 102. The patient may access a designated website or an application repository such as the App Store™ or Google Play™ via the communication network 48 for downloading the application. In another embodiment, the patient may access the application from the designated website via the internet connection.

The patient may then calibrate the sensors 14 and microphones 16 and start a monitoring session via the graphical user interface of the application, as shown in block 104. Alternatively, the processor 18 may automatically calibrate the sensors 14 and microphones 16 when turned on or when a monitoring session is started.

The processor 18 of the wearable garment 12 may activate the sensors 14 and microphones 16 and instruct the sensors 14 and microphones 16 to begin sensing heart beats, temperature, oxygen level, and other vital signs of the patient, as shown in block 106. The patient or the caregiver may selectively activate a portion of the sensors or microphones via the graphical user interface of the patient computing device 26 or the caregiver computing device 28.

The processor 18 may then store the signals in the form of computer readable data and/or recordings on the memory 20, as shown in block 108. The data and/or recordings may be stored only temporarily (e.g., until transmitted or overwritten after a predetermined period of time) or permanently stored until selectively deleted.

The processor 18 may then transmit the collected data and/or recordings to the patient computing device 26 over the wireless communication network 48, as shown in block 110. The data and/or recordings may be encrypted or secured so as to comply with HIPPA or other privacy regulations.

The application may then determine blood pressure, electrocardiogram, heart rate and rhythm, respiratory rate, body temperature, oxygen saturation, thoracic impedance, and other vital information by analyzing the data and recordings, as shown in block 112. This information may be displayed in an easily read and understandable format on the graphical user interface of the patient computing device 26 or the caregiver computing device 28.

The application may then calculate cardiac output, cardiac index, stroke volume, systemic vascular resistance, and thoracic fluid content based on the above determinations by utilizing readily available scientific formulas, as shown in block 114. This information may be displayed in an easily read and understandable format on the graphical user interface of the patient computing device 26 or the caregiver computing device 28.

The application may also detect other health issues such as lung and cardiac auscultations by comparing the collected data against information in the pre-developed archive, as shown in block 116. The application may also generate alerts upon detection of moderate or severe health issues that require urgent or immediate attention.

The patient may then manage sensor readings and other information via the graphical user interface of the application and selectively transmit sensor readings and other information to the caregiver computing devices 28 and/or healthcare provider computing system 30, as shown in block 118. Alternatively, the application may automatically transmit the sensor readings and other information to the caregiver computing devices 28 and/or healthcare provider computing system 30. In either transmission mode, the application may encrypt or secure the information so as to comply with HIPPA or other privacy regulations.

The caregiver computing devices 28 and/or healthcare provider computing system 30 may then provide or suggest a diagnosis based on the analysis to the caregiver via one of the caregiver computing devices 28, as shown in block 120. The diagnosis may be presented in the form of a medical report, notification, or alert.

The caregiver may then communicate with the patient over the wireless communication network 48 via the patient computing device 26 and the caregiver computing device 28 to ask follow-up questions, provide advice and patient education, provide a patient evaluation, present treatment options, prescribe medicine, and continue monitoring the patient, as shown in block 122. This information may be presented via the graphical user interfaces of the patient computing device 26 and the caregiver computing device 28.

The patient and the caregiver or other healthcare provider personnel may also conduct a live interview with the patient via the patient computing device 26 and the caregiver computing device 28, as shown in block 124. The live interview and other communications between the patient and the caregiver may be saved and stored along with other medical information of the patient.

The above described invention provides many advantages over the prior art. For example, the wearable garment 12 is a non-invasive, easy-to-wear garment with a wireless-enabled processor 18 that allows the patient's vital signs to be monitored while the patient performs day-to-day activities. That is, the patient does not need to visit the hospital or be hooked up to a monitoring station for evaluation. The left and right fenestrated areas 38 allow the wearable garment 12 to be positioned closer to the patient's chest wall for improved sensing and more accurate results. The application allows the patient to easily initiate monitoring sessions, manage collected data, and transmit the data to the caregiver computing device 28 and healthcare provider computing system 30. The monitoring system 10 allows a single caregiver to monitor more than one patient at a time and allows a single patient to communicate with, and benefit from the expertise of, a number of caregivers and specialists.

Although the invention has been described with reference to the embodiments illustrated in the attached drawing figures, it is noted that equivalents may be employed and substitutions made herein without departing from the scope of the invention.

Having thus described various embodiments of the invention, what is claimed as new and desired to be protected by Letters Patent includes the following:

1. A respiratory and cardiovascular monitoring system comprising:
a wearable garment configured to be worn close to a patient's chest wall;
a plurality of sensors positioned on or embedded in the wearable garment for sensing blood pressure and body temperature of a patient;
a plurality of microphones positioned on or embedded in the wearable garment for sensing lung and heart auscultations of the patient;
a processor positioned on or embedded in the wearable garment for controlling the sensors and microphones, processing signals received from the sensors and microphones, and creating recordings and computer data corresponding to the signals;
a memory component positioned on or embedded in the wearable garment for storing the signals, recordings, and data thereon; and
a transceiver positioned on or embedded in the wearable garment for transmitting the signals, recordings, and data to other computing devices over a wireless communication network, the sensors and microphones being configured to be activated over the wireless communication network via the transceiver and the processor such that the vest is configured to be fully operated by the patient.

2. The respiratory and cardiovascular monitoring system of claim 1, wherein the wearable garment is a vest including:
a neck opening;
left and right arm openings; and
a torso opening.

3. The respiratory and cardiovascular monitoring vest of claim 2, the vest further comprising left and right front fenestrated areas configured to receive the patient's breasts or soft tissue therethrough for ensuring that the vest fits snugly against the patient's chest wall.

4. The respiratory and cardiovascular monitoring system of claim 2, the vest further comprising a front placket for allowing the patient to easily put on and remove the vest.

5. The respiratory and cardiovascular monitoring system of claim 2, the vest further comprising a plurality of buckles for allowing the patient to adjustably secure the vest close to his or her chest wall.

6. The respiratory and cardiovascular monitoring system of claim 1, the plurality of sensors comprising electrocardiography sensors for detecting heart rate and rhythm abnormalities of the patient's heart.

7. The respiratory and cardiovascular monitoring system of claim 6, the electrocardiography sensors being electrocardiography patches.

8. The respiratory and cardiovascular monitoring system of claim 6, the electrocardiography sensors being positioned in an upper right front area, an upper left front area, a middle right front area, a middle left front area of the wearable garment.

9. The respiratory and cardiovascular monitoring system of claim 1, the plurality of sensors comprising non-invasive hemodynamic sensors for detecting blood pressure, heart rate, and thoracic impedance.

10. The respiratory and cardiovascular monitoring system of claim 9, the non-invasive hemodynamic sensors being positioned in an upper right front area, an upper left front area, a lower right front area, and a lower left front area of the wearable garment.

11. The respiratory and cardiovascular monitoring system of claim 1, the microphones being positioned in an upper left back area, an upper right back area, a middle left back area, a middle right back area, a lower left back area, a lower right back area, an upper right front area, an upper left front area, a middle left side, and a middle right side of the wearable garment.

12. The respiratory and cardiovascular monitoring system of claim 1, further comprising a power source positioned on the wearable garment for powering the sensors, microphones, processor, memory, and transceiver.

13. A system for respiratory and cardiovascular monitoring, evaluation, and treatment of a patient, the system comprising:
a respiratory and cardiovascular monitoring wearable garment comprising:
a neck opening;
left and right arm openings; and
a torso opening, the wearable garment being configured to be worn close to the patient's chest wall for improving monitoring signals;
a plurality of sensors positioned on or embedded in the wearable garment for sensing blood pressure and body temperature of the patient;
a plurality of microphones positioned on or embedded in the wearable garment for sensing lung and heart auscultations of the patient;
a processor positioned on or embedded in the wearable garment for controlling the sensors and microphones, processing signals received from the sensors and microphones, and creating recordings and computer data corresponding to the signals;
a memory component positioned on or embedded in the wearable garment for storing the signals, recordings, and computer data thereon;
a transceiver positioned on or embedded in the wearable garment for transmitting the signals, recordings, and computer data to other computing devices over a wireless communication network;
a power source positioned on or embedded in the wearable garment for powering the sensors, microphones, processor, memory, and transceiver; and
a patient computing device configured to run a monitoring application thereon for managing the signals, recordings, and computer data received from the processor of the wearable garment, the patient computing device including a graphical user interface including a plurality of virtual inputs for allowing the patient to initiate self-monitoring sessions.

14. The system of claim 13, further comprising a caregiver computing device configured to run the monitoring application thereon, the caregiver computing device being configured to communicate with the patient computing device for allowing a caregiver to interact with the patient.

15. The system of claim 14, wherein the caregiver computing device is further configured to communicate with a plurality of patient computing devices for allowing the caregiver to interact with a plurality of patients.

16. The system of claim 13, further comprising a healthcare provider computing system configured to run a healthcare provider website for allowing patients to download the monitoring application therefrom, the healthcare provider computing system including a memory component for storing signals, recordings, and computer data of a number of patients thereon.

17. The system of claim 16, wherein the healthcare provider computing system is further configured to provide a diagnosis based on analysis of the computer data received from the wearable garment.

18. The system of claim 13, wherein the patient computing device comprises a graphical user interface for activating the sensors and microphones of the wearable garment.

19. The system of claim 18, wherein the sensors and microphones are configured to be calibrated via the graphical user interface.

20. A system for respiratory and cardiovascular monitoring, evaluation, and treatment of a patient, the system comprising:
a wearable vest comprising:
a neck opening;
left and right arm openings;
a torso opening; and
left and right front fenestrated areas configured to receive the patient's breasts or soft tissue therethrough for ensuring that the vest fits snugly against the patient's chest wall;
a plurality of sensors positioned on or embedded in the wearable vest for sensing blood pressure and body temperature of the patient, the sensors including four electrocardiography sensors;
a plurality of microphones positioned on or embedded in the wearable vest for sensing lung and heart auscultations of the patient;
a processor positioned on or embedded in the wearable vest for controlling the sensors and microphones, processing signals received therefrom, and creating recordings and computer data corresponding to the signals;
a memory component positioned on or embedded in the wearable vest for storing the signals, recordings, and computer data thereon;
a transceiver positioned on or embedded in the wearable vest for transmitting the signals, recordings, and data to other computing devices over a wireless communication network;
a power source positioned on or embedded in the wearable vest for powering the sensors, microphones, processor, memory, and transceiver;
a patient computing device for running a monitoring application thereon for managing the signals, recordings, and computer data received from the processor of the vest;
a caregiver computing device for running the monitoring application thereon, the caregiver computing device being configured to communicate with the patient computing device and other patient computing devices for allowing a caregiver to interact with a plurality of patients; and
a healthcare provider computing system configured to run a healthcare provider website for allowing patients to download the monitoring application therefrom, the healthcare provider computing system including a memory component for storing signals, recordings, and computer data of a number of patients thereon.
